(19) United States
(12) Patent Application Publication
(10) Pub. No.: US 2026/0194784 A1
(43) Pub. Date: Jul. 9, 2026

(54) SYSTEMS AND METHODS FOR ROUTING SINGLE PHOTONS FROM A TRAPPED ION USING A PHOTONIC INTEGRATED CIRCUIT

(71) Applicants: John HANNEGAN, College Park, MD (US); UNIVERSITY OF MARYLAND, COLLEGE PARK, College Park, MD (US); MASSACHUSETTS INSTITUTE OF TECHNOLOGY, Cambridge, MA (US); THE UNITED STATES OF AMERICA AS REPRESENTED BY THE SECRETARY OF THE ARMY, ARMY RESEARCH LABORATORY, Washington, DC (US)

(72) Inventors: Uday SAHA, Newark, DE (US); Edo WAKS, Washington, DC (US); James D. SIVERNS, College Park, MD (US); John HANNEGAN, College Park, MD (US); Mihika PRABHU, Cambridge, MA (US); Dirk ENGLUND, Cambridge, MA (US); Qudsia QURAISHI, Washington, DC (US)

(21) Appl. No.: 19/132,548

(22) PCT Filed: Dec. 4, 2023
(86) PCT No.: PCT/US2023/082346

§ 371 Date: May 23, 2025

Related U.S. Application Data
(60) Provisional application No. 63/386,101, filed on Dec. 5, 2022.

(51) Int. Cl. G02F 1/225; B82Y 20/00; G02F 1/21; G06N 10/40; H04B 10/70

(52) U.S. Cl. CPC G02F 1/225; B82Y 20/00; G02F 1/212; G06N 10/40; H04B 10/70

(57) ABSTRACT

A system includes a quantum source and an optical device coupled to the quantum source. The quantum source is configured to emit an entangled photon. The optical device is configured to route the entangled photon to one or more outputs. In some aspects, the optical device can include a photonic integrated circuit (PIC). Advantageously the system can provide a routing scheme to route (e.g., passively, actively, dynamically, or a combination thereof) entangled photons from one or more quantum sources (e.g., trapped ion, single-photon source, quantum emitter, etc.) between different nodes, a quantum frequency conversion scheme to match near-infrared photons (750 nm to 1260 nm) and/or telecommunication photons (1260 nm to 1675 nm) entangled with photons from one or more quantum sources to an operating wavelength of the optical device (e.g., PIC), programmable routing and entanglement distribution, and scalable long-distance quantum networks.

### CROSS-REFERENCE TO RELATED APPLICATION

This application claims priority to U.S. Provisional Application No. 63/386,101, filed Dec. 5, 2022, which is hereby incorporated herein in its entirety by reference.

This invention was made with government support under OIA2134891 awarded by the National Science Foundation (NSF). The government has certain rights in the invention.

### FIELD

The present disclosure relates to quantum network apparatuses, systems and methods, for example, quantum router apparatuses, systems, and methods based on photonic integrated circuits to build scalable quantum networks.

### BACKGROUND

Quantum computing, simulation, and communication platforms based on trapped ions are at the forefront of quantum information science. Trapped ion systems are well suited for quantum networking given their long coherence times, high single and two-qubit gate fidelities, and their ability to emit photons entangled with the trapped ion's internal states. Of particular interest are photons produced via S-P dipole transitions, enabling direct entanglement between the photons and commonly used ground-state qubits of ions, for example, ytterbium ions (Yb⁺), barium ions (Ba⁺), and strontium ions (Sr⁺). Ground-state qubits currently demonstrate the longest coherence times in trapped ions, as well as leading two-qubit gate fidelities. Trapped ions are one candidate for nodes of a scalable quantum network. Future quantum networks based on trapped ions may require a scalable way to route entangled photons between different network nodes.

Photonic integrated circuits from fabrication foundries offer a compact and scalable solution for programmable routing of entangled photons. A photonic integrated circuit (PIC) or integrated optical circuit is a microchip containing two or more photonic components that form a functioning circuit to transport, route, detect, and process photons. The PIC can include passive and active optical functions on the same microchip, and the PIC can be made from a variety of different materials for different optical applications.

However, PICs typically operate at telecommunication wavelengths, which are incompatible with the range of strong dipole emissions of trapped ions at ultra-violet (UV) and visible wavelengths, where light suffers large propagation losses.

### SUMMARY

Accordingly, there is a need to better match emission wavelengths of trapped ions to facilitate implementation in telecommunication systems. Further, there is a need for a quantum router to provide a routing scheme to route (e.g., passively, actively, dynamically, or a combination thereof) entangled photons from one or more quantum sources (e.g., trapped ion, single-photon source, quantum emitter, etc.) between different nodes of a quantum network, a quantum frequency conversion scheme to match near-infrared photons (e.g., 750 nm to 1260 nm) and/or telecommunication photons (e.g., 1260 nm to 1675 nm) entangled with photons from one or more quantum sources to an operating wavelength of an optical device (e.g., PIC), programmable routing and entanglement distribution, and scalable long-distance quantum networks.

In some aspects, a system can include a quantum source and an optical device. In some aspects, the quantum source can be configured to emit an entangled photon. In some aspects, the optical device can be coupled to the quantum source. In some aspects, the optical device can be configured to route the entangled photon to one or more outputs.

In some aspects, a wavelength of the entangled photon is in the ultraviolet and visible regime of about 100 nm to about 750 nm. In some aspects, the quantum source can include a trapped ion, a single-photon source, a quantum emitter, a superconducting qubit, a photonic qubit, or a combination thereof. In some aspects, the quantum source can be disposed on the optical device.

In some aspects, the optical device can include at least one splitter. In some aspects, the at least one splitter can have a splitting ratio of about 50%.

In some aspects, the optical device can include a passive optical device. In some aspects, the passive optical device can include a multi-mode interferometer, a photonic integrated device, or a combination thereof.

In some aspects, the optical device can include an active optical device. In some aspects, the active optical device can include a photonic integrated circuit. In some aspects, the photonic integrated circuit can include silicon, silicon nitride, silicon carbide, lithium niobate, or a combination thereof.

In some aspects, the photonic integrated circuit can include at least one splitter configured to route the entangled photon. In some aspects, the photonic integrated circuit can include at least one phase shifter configured to adjust a phase difference between the one or more outputs.

In some aspects, the photonic integrated circuit can include a first splitter configured to route the entangled photon. In some aspects, the photonic integrated circuit can include a first phase shifter configured to adjust a phase difference between one or more intermediate waveguides. In some aspects, the photonic integrated circuit can include a second splitter configured to route the entangled photon. In some aspects, the photonic integrated circuit can include a second phase shifter configured to adjust a phase difference between the one or more outputs.

In some aspects, the photonic integrated circuit can be in a Mach-Zehnder interferometer configuration.

In some aspects, the photonic integrated circuit can include an optical filter, a short pass filter, a long pass filter, a band pass filter, or a combination of filters configured to filter the entangled photon.

In some aspects, the system can further include a quantum frequency conversion stage between the quantum source and the optical device. In some aspects, the quantum frequency conversion stage can be configured to convert the entangled photon to a near-infrared photon of about 750 nm to about 1260 nm.

In some aspects, the system can further include two or more quantum frequency conversion stages between the quantum source and the optical device. In some aspects, the two or more quantum frequency conversion stages can be configured to convert the entangled photon to a telecommunication photon of about 1260 nm to about 1675 nm.

In some aspects, a system can include a plurality of quantum sources and an optical device. In some aspects, the plurality of quantum sources can be configured to emit a plurality of entangled photons. In some aspects, the optical device can be coupled to the plurality of quantum sources. In some aspects, the optical device can be configured to route the plurality of entangled photons to one or more outputs.

In some aspects, the plurality of quantum sources can be disposed on the optical device. In some aspects, the optical device can include at least one splitter and at least one combiner.

In some aspects, the system can further include one or more quantum frequency conversion stages between the plurality of quantum sources and the optical device. In some aspects, the one or more quantum frequency conversion stages can be configured to convert the plurality of entangled photons to near-infrared photons of about 750 nm to about 1260 nm. In some aspects, the one or more quantum frequency conversion stages can be configured to convert the plurality of entangled photons to telecommunication photons of about 1260 nm to about 1675 nm. In some aspects, the one or more quantum frequency conversion stages can be configured to convert the plurality of entangled photons to near-infrared photons of about 750 nm to about 1260 nm, to telecommunication photons of about 1260 nm to about 1675 nm, or to a combination thereof.

In some aspects, a method of routing entangled photons between different nodes can include generating one or more entangled photons from one or more quantum sources. In some aspects, the method can further include routing the one or more entangled photons to one or more outputs of an optical device coupled to the one or more quantum sources.

In some aspects, the method can further include matching a wavelength of the one or more entangled photons to an operating wavelength of the optical device. In some aspects, matching the wavelength can include applying one or more quantum frequency conversion stages between the one or more quantum sources and the optical device. In some aspects, the wavelength of the entangled photon can be in the ultraviolet and visible regime of about 100 nm to about 750 nm. In some aspects, the operating wavelength of the optical device can be in the ultraviolet and visible regime of about 100 nm to about 750 nm. In some aspects, the operating wavelength of the optical device can be in the near-infrared regime of about 750 nm to about 1260 nm. In some aspects, the operating wavelength of the optical device can be in the telecommunication regime of about 1260 nm to about 1675 nm. In some aspects, the operating wavelength of the optical device can be in the ultraviolet and visible regime of about 100 nm to about 750 nm, the near-infrared regime of about 750 nm to about 1260 nm, the telecommunication regime of about 1260 nm to about 1675 nm, or a combination thereof.

In some aspects, routing the one or more entangled photons can include switching the one or more entangled photons between the one or more outputs with one or more splitters and one or more phase shifters. In some aspects, routing can include cross-connecting the one or more entangled photons to a plurality of nodes in an N×N array in the optical device.

In some aspects, a quantum network can include two or more quantum sources, two or more quantum modems, and a quantum router. In some aspects, the two or more quantum sources can each be configured to emit an entangled photon. In some aspects, each quantum modem can be coupled to a quantum source. In some aspects, each quantum modem can be configured to convert emitted entangled photons produced by the quantum source into telecommunication photons of about 1260 nm to about 1675 nm through one or more quantum frequency conversion devices. In some aspects, the quantum router can be configured to receive the telecommunication photons and route the telecommunication photons to one or more outputs.

In some aspects, a wavelength of the telecommunication photons can match an operating wavelength of the quantum router. In some aspects, the quantum router can include a multi-mode interferometer, a photonic integrated circuit, or a combination thereof. In some aspects, the quantum network can be configured for distributed quantum computing between the two or more quantum sources.

Implementations of any of the techniques described above can include a system, a method, a process, a device, and/or an apparatus. The details of one or more implementations are set forth in the accompanying drawings and the description below. Other features will be apparent from the description and drawings, and from the claims.

Further features and exemplary aspects of the present disclosure, as well as the structure and operation of various aspects, are described in detail below with reference to the accompanying drawings. It is noted that the aspects are not limited to the specific aspects described herein. Such aspects are presented herein for illustrative purposes only. Additional aspects will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the aspects and, together with the description, further serve to explain the principles of the aspects and to enable a person skilled in the relevant art(s) to make and use the aspects.

FIG. 1 is a schematic illustration of a quantum network, according to an exemplary aspect.

FIG. 2 is a schematic illustration of a quantum network based on a trapped ion source, according to an exemplary aspect.

FIG. 3 is a schematic illustration of a quantum modem, according to an exemplary aspect.

FIG. 4 is a schematic illustration of a quantum router, according to an exemplary aspect.

FIG. 5 shows a plot of transmission as a function of current for the quantum router shown in FIG. 4, according to an exemplary aspect.

FIG. 6 shows a plot of splitting ratio as a function of current for the quantum router shown in FIG. 4, according to an exemplary aspect.

FIG. 7 shows a plot of time resolved photon counts for the quantum router shown in FIG. 4 in a first configuration, according to an exemplary aspect.

FIG. 8 shows a plot of time resolved photon counts for the quantum router shown in FIG. 4 in the first configuration, according to an exemplary aspect.

FIG. 9 shows a plot of time resolved photon counts for the quantum router shown in FIG. 4 in a second configuration, according to an exemplary aspect.

FIG. 10 shows a plot of time resolved photon counts for the quantum router shown in FIG. 4 in the second configuration, according to an exemplary aspect.

FIG. 11 shows a plot of time resolved photon counts for the quantum router shown in FIG. 4 in a third configuration, according to an exemplary aspect.

FIG. 12 shows a plot of time resolved photon counts for the quantum router shown in FIG. 4 in the third configuration, according to an exemplary aspect.

FIG. 13 is a schematic illustration of a quantum network based on a plurality of trapped ion sources on a microchip, according to an exemplary aspect.

FIG. 14 is a schematic illustration of a quantum network based on a plurality of quantum sources, according to an exemplary aspect.

FIG. 15 is a schematic illustration of a quantum network based on a plurality of quantum sources, according to an exemplary aspect.

FIG. 16 illustrates a flow diagram for a quantum network, according to an exemplary aspect.

The features and exemplary aspects of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

Provided herein are system, apparatus, device, method, and/or computer program product aspects, and/or combinations and sub-combinations thereof, for routing entangled photons from one or more quantum sources to different nodes of a quantum network.

A system as described below can route one or more entangled photons from one or more quantum sources in a programmable way to one or more different nodes in a quantum network. Further, the system as described below can match a wavelength of one or more entangled photons from one or more quantum sources to an operating wavelength of an optical device (e.g., PIC) coupled to the one or more quantum sources.

This specification discloses one or more aspects that incorporate the features of this present disclosure. The disclosed aspect(s) merely exemplify the present disclosure. The scope of this disclosure is not limited to the disclosed aspect(s). The present disclosure is defined by the claims appended hereto.

The aspect(s) described, and references in the specification to “one aspect,” “an aspect,” “an example aspect,” “some aspects,” etc., indicate that the aspect(s) described can include a particular feature, structure, and/or characteristic, but every aspect may not necessarily include the particular feature, structure, and/or characteristic. Moreover, such phrases are not necessarily referring to the same aspect. Further, when a particular feature, structure, and/or characteristic is described in connection with an aspect, it is understood that it is within the knowledge of one skilled in the art(s) to effect such feature, structure, and/or characteristic in connection with other aspects whether or not explicitly described.

Spatially relative terms, such as “beneath,” “below,” “lower,” “above,” “on,” “upper,” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (rotated 90 degrees or at other orientations) and the spatially relative descriptors used herein may likewise be interpreted accordingly.

The term “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value).

Numerical values, including endpoints of ranges, can be expressed herein as approximations preceded by the term “about,” “substantially,” “approximately,” or the like. In such cases, other aspects include the particular numerical value. Regardless of whether a numerical value is expressed as an approximation, two aspects are included in this disclosure: one expressed as an approximation, and another not expressed as an approximation. It will be further understood that an endpoint of each range is significant both in relation to another endpoint, and independently of another endpoint.

Aspects of the disclosure may be implemented in hardware, firmware, software, or any combination thereof. Aspects of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustic, or other forms of propagated signals (e.g., carrier waves, infrared signals, digital signals, etc.), and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, instructions, etc.

The term “noise photon” or “noise photons” as used herein indicates unconverted signal photons (e.g., from a quantum source), Raman anti-Stokes noise photons (e.g., due to Raman scattering processes), and/or photons from one or more pump lasers.

### Exemplary Quantum Networks

As discussed above, trapped ion systems are well suited for quantum networking, given their long coherence times, high single and two-qubit gate fidelities, and their ability to emit photons entangled with the trapped ion's internal states. Of particular interest are photons produced via S-P dipole transitions, enabling direct entanglement between the photons and commonly used ground-state qubits of ions, for example, ytterbium ions (Yb⁺), barium ions (Ba⁺), and strontium ions (Sr⁺). Ground-state qubits currently demonstrate the longest coherence times in trapped ions, as well as leading two-qubit gate fidelities. Trapped ions are one candidate for nodes of a scalable quantum network. Future quantum networks based on trapped ions may require a scalable way to route entangled photons between different network nodes.

Photonic integrated circuits from fabrication foundries offer a compact and scalable solution for programmable routing of entangled photons. A photonic integrated circuit (PIC) or integrated optical circuit is a microchip containing two or more photonic components (e.g., waveguides, splitters, combiners, phase shifters, directional couplers, or a combination thereof) that form a functioning circuit to transport, route, detect, and process photons. The PIC can provide quantum interconnects to route photons between nodes of a trapped ion quantum network. The PIC can act as reconfigurable optical cross-connect switches (e.g., in an N×N array or in any other unitary matrix transformations (e.g., 2×2 array, 3×3 array, 4×4 array, 5×5 array, etc.)) that can control the path of photonic qubits within the network in a programmable way. The PIC can include passive and active optical functions on the same microchip, and the PIC can be made from a variety of different materials (e.g., silicon, silicon nitride, silicon carbide, indium phosphide, lithium niobate, silica, gallium arsenide, etc.) for different optical applications.

However, PICs typically operate at telecommunication wavelengths (e.g., about 1260 nm to about 1675 nm), which are incompatible with the range of strong dipole emissions of trapped ions at ultra-violet (UV) and visible wavelengths (e.g., about 100 nm to about 750 nm), where light suffers large propagation losses.

Aspects of quantum network apparatuses, systems, and methods as discussed below can provide a routing scheme to route (e.g., passively, actively, dynamically, or a combination thereof) entangled photons from one or more quantum sources (e.g., trapped ion, single-photon source, quantum emitter, superconducting qubit, photonic qubit, or a combination thereof) between different nodes of a quantum network, a quantum frequency conversion scheme to match near-infrared photons (e.g., about 750 nm to about 1260 nm) and/or telecommunication photons (e.g., about 1260 nm to about 1675 nm) entangled with photons from one or more quantum sources to an operating wavelength of an optical device (e.g., PIC), programmable routing and entanglement distribution, and scalable long-distance quantum networks.

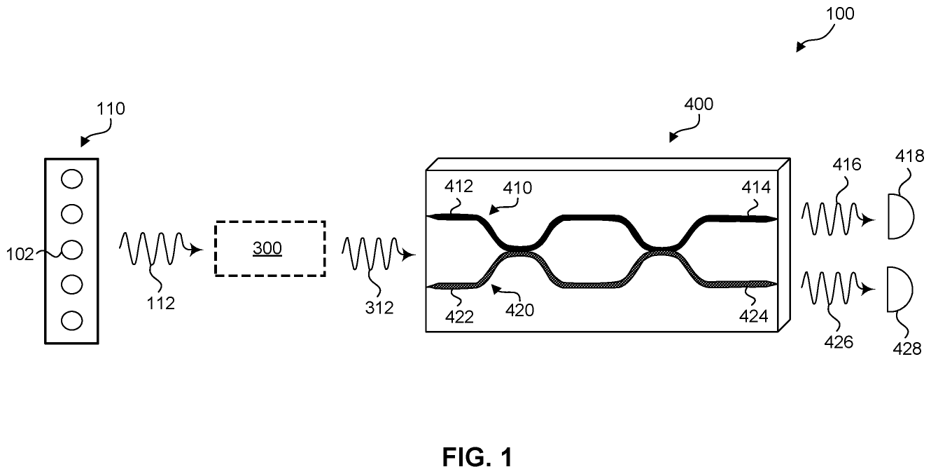

FIG. 1 illustrates quantum network 100, according to various exemplary aspects. Quantum network 100 can be configured to route (e.g., passively, actively, dynamically, or a combination thereof) entangled photons from one or more quantum sources (e.g., trapped ion, single-photon source, quantum emitter, etc.) between different nodes. Quantum network 100 can be further configured to match (e.g., via one or more quantum modems 300) near-infrared photons (e.g., about 750 nm to about 1260 nm) and/or telecommunication photons (e.g., about 1260 nm to about 1675 nm) entangled with photons from one or more quantum sources to an operating wavelength of an optical device (e.g., quantum router 400). Quantum network 100 can be further configured for programmable routing and entanglement distribution. Quantum network 100 can be further configured for distributed quantum computing between two or more quantum sources.

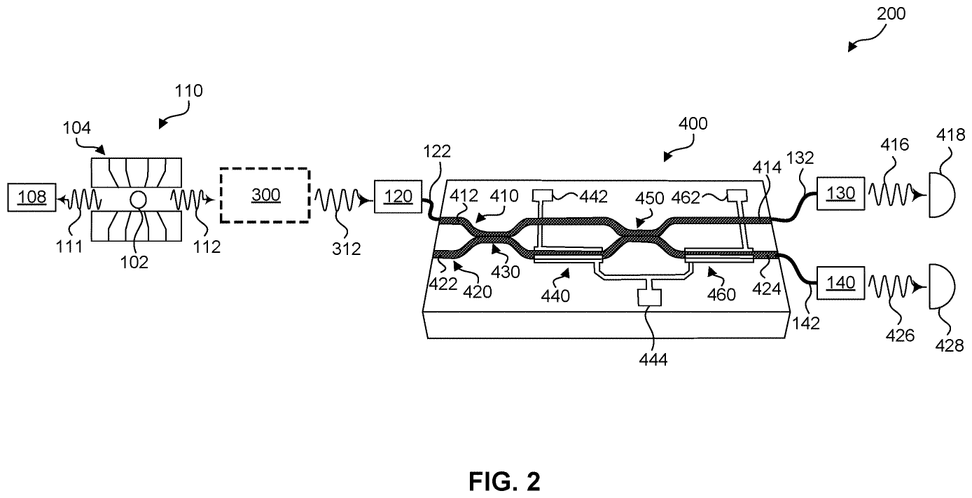

Although quantum network 100 is shown in FIG. 1 as a stand-alone apparatus and/or system, the aspects of this disclosure can be used with other apparatuses, systems, and/or methods, such as, but not limited to, elements in FIGS. 2-16, e.g., quantum network 200, quantum modem 300, quantum router 400, quantum network 200′, quantum network 100′, quantum network 100″, and/or flow diagram 1600.

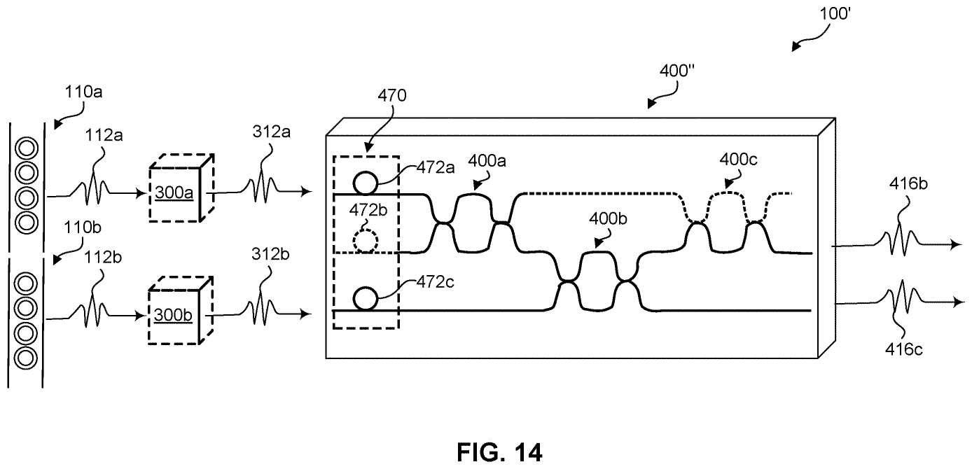

As shown in FIG. 1, quantum network 100 can include quantum source 110, quantum modem 300, and quantum router 400. In some aspects, quantum network 100 can include a plurality of quantum sources configured to emit a plurality of entangled photons. For example, as shown in FIG. 14, quantum network 100′ can include first and second trapped ion stages 110a, 110b emitting first and second entangled photons 112a, 112b. In some aspects, quantum network 100 can omit quantum modem 300, for example, utilizing entangled photon 112 from quantum source 110 as input to quantum router 400 without any quantum frequency conversion.

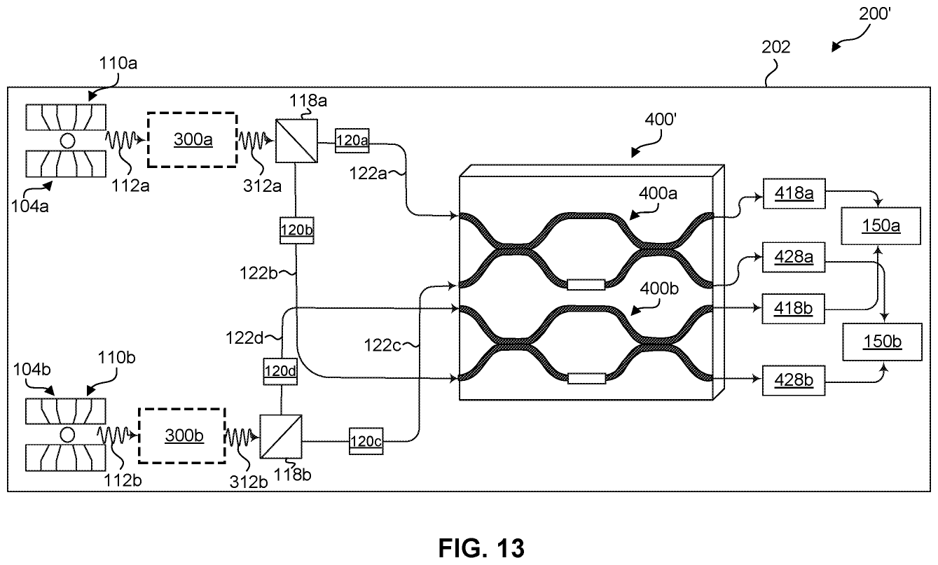

Quantum source 110 can be configured to emit entangled photon 112. In some aspects, quantum source 110 can include a trapped ion, a single-photon source, a quantum emitter, a superconducting qubit, a photonic qubit, or a combination thereof. As shown in FIG. 1, quantum source 110 can include one or more qubits 102 (e.g., trapped ions) and emit entangled photon 112 from the one or more qubits 102. In some aspects, a wavelength of entangled photon 112 can be in the ultraviolet and visible regime of about 100 nm to about 750 nm, for example, entangled photon 112 can have a wavelength of about 493 nm (e.g., corresponding to emission from trapped barium-138 ion). In some aspects, quantum source 110 can be disposed on or adjacent to quantum router 400. In some aspects, quantum source 110 and quantum router 400 can be disposed on a common platform. For example, as shown in FIG. 13, one or more quantum sources 110a, 110b can be disposed on microchip 202 along with quantum router 400′.

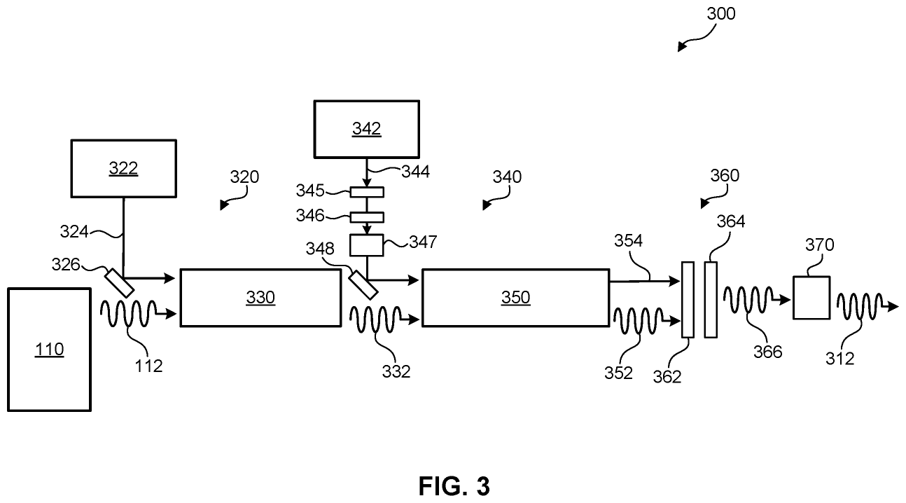

Quantum modem 300 can be configured to convert entangled photon 112 to tuned converted photon 312. Quantum modem 300 can be further configured to match (e.g., tune) a wavelength of entangled photon 112 to an operating wavelength of quantum router 400 via one or more quantum frequency conversion (QFC) stages (e.g., first QFC stage 320 and/or second QFC stage 340 (FIG. 3)), thereby generating tuned converted photon 312. Quantum modem 300 is described in further detail below with reference to FIG. 3. As shown in FIG. 1, quantum modem 300 can convert entangled photon 112 (e.g., about 493 nm wavelength) from quantum source 110 to tuned converted photon 312 (e.g., about 1534 nm wavelength) via one or more quantum frequency conversion stages. In some aspects, quantum modem 300 can be between quantum source 110 and quantum router 400.

In some aspects, quantum modem 300 can be configured to convert entangled photon 112 to a near-infrared photon of about 750 nm to about 1260 nm (e.g., first converted photon 332 (FIG. 3)). In some aspects, quantum modem 300 can be configured to convert entangled photon 112 to a telecommunication photon of about 1260 nm to about 1675 nm (e.g., second converted photon 352 (FIG. 3.)).

In some aspects, tuned converted photon 312 can have a wavelength in a range of about 100 nm to about 1675 nm. In some aspects, tuned converted photon 312 can have a wavelength in the UV and visible regime (e.g., about 100 nm to about 750 nm). In some aspects, tuned converted photon 312 can have a wavelength in the near-infrared regime (e.g., about 750 nm to about 1260 nm). In some aspects, tuned converted photon 312 can have a wavelength in the telecom regime (e.g., about 1260 nm to about 1675 nm), for example, O-band (e.g., 1260 nm to 1360 nm), E-band (e.g., 1360 nm to 1460 nm), S-band (e.g., 1460 nm to 1530 nm), C-band (e.g., 1530 nm to 1565 nm), L-band (e.g., 1565 nm to 1625 nm), U-band (e.g., 1625 nm to 1675 nm), or a combination thereof.

In some aspects, tuned converted photon 312 can have a wavelength that matches an operating wavelength of quantum router 400. In some aspects, tuned converted photon 312 can be a near-infrared photon having a wavelength of about 750 nm to about 1260 nm. In some aspects, tuned converted photon 312 can be a telecommunication photon having a wavelength of about 1260 nm to about 1675 nm.

Quantum router 400 can be configured to route entangled photon 112 (or tuned converted photon 312) to one or more outputs (e.g., first and second outputs 414, 424). Quantum router 400 can be further configured to route entangled photon 112 (or tuned converted photon 312) through one or more photonic components (e.g., splitters) to one or more outputs (e.g., first and second outputs 414, 424). Quantum router 400 is described in further detail below with reference to FIGS. 2 and 4-12. As shown in FIG. 1, quantum router 400 can include first waveguide 410 and second waveguide 410. First waveguide 410 can be configured to route entangled photon 112 in a programmable way (e.g., to first output 414 and/or second output 424). First waveguide 410 can include first input 412 and first output 414. Second waveguide 420 can be configured to route entangled photon 112 in a programmable way (e.g., to first output 414 and/or second output 424). Second waveguide 420 can include second input 422 and second output 424.

As described herein, reference to entangled photon 112 alternatively includes reference to tuned converted photon 312, for the case in which quantum modem 300 is employed to convert a wavelength of entangled photon 112 to a desired wavelength (e.g., to match an operating wavelength of quantum router 400). In some aspects, quantum router 400 can receive entangled photon 112. In some aspects, quantum router 400 can receive tuned converted photon 312, which is entangled with entangled photon 112.

In some aspects, quantum router 400 can receive entangled photon 112 (e.g., at first input 412) and route entangled photon 112 though quantum router 400 to output first entangled output photon 416 (e.g., at first output 414) and/or second entangled output photon 426 (e.g., at second output 424). In some aspects, quantum router 400 can receive one or more entangled photons 112 (e.g., at first input 412 and/or second input 422) and route entangled photons 112 through quantum router 400 in a programmable way to first output 414 (e.g., outputting first entangled output photon 416), second output 424 (e.g., outputting second entangled output photon 416), or both.

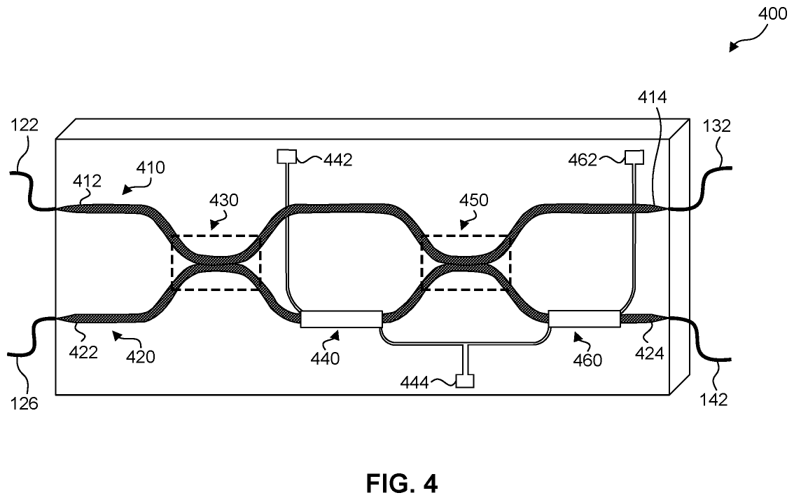

In some aspects, quantum router 400 can include one or more photonic components (e.g., waveguides, splitters, combiners, phase shifters, directional couplers, or a combination thereof) configured to transport, route, detect, and process entangled photons 112. For example, as shown in FIG. 4, quantum router 400 (e.g., PIC) can include first splitter 430 (and/or combiner), first phase shifter 440 (e.g., internal phase control), second splitter 450 (and/or combiner), and second phase shifter 460 (e.g., external phase control) to route entangled photons 112 in a programmable way to one or more nodes (e.g., first output 414 and/or second output 424). In some aspects, quantum router 400 can include first detector 418 and second detector 428 configured to measure photons received at first output 414 (e.g., first entangled output photon 416) and at second output 424 (e.g., second entangled output photon 426), respectively.

In some aspects, quantum router 400 can include one or more passive optical devices. For example, quantum router 400 can include a multi-mode interferometer, a photonic integrated circuit, or a combination thereof. In some aspects, quantum router 400 can include one or more active optical devices. For example, as shown in FIG. 4, quantum router 400 can include a photonic integrated circuit (PIC). In some aspects, quantum router 400 can include one or more passive optical devices, one or more active optical devices, or a combination thereof. In some aspects, quantum router 400 (e.g., PIC) can include silicon, silicon nitride, silicon carbide, lithium niobate, or a combination thereof.

In some aspects, quantum router 400 can include at least one splitter. For example, as shown in FIG. 2, quantum router 400 can include first splitter 430 configured to split first and second waveguides 410, 420. In some aspects, the at least one splitter can have a splitting ratio of about 50%. For example, as shown in FIG. 6, first splitter 430 of quantum router 400 can generate a 50/50 splitting condition between first and second waveguides 410, 420. In some aspects, quantum router 400 can include at least one splitter and at least one combiner. In some aspects, quantum router 400 can include a splitter and/or combiner (e.g., first splitter 430 (FIG. 4)) that is programmable to either split one input photon into two output photons or combine two input photons into one output photon.

In some aspects, quantum router 400 (e.g., PIC) can include at least one splitter (e.g., first splitter 430 (FIG. 4)) configured to route entangled photon 112 (or tuned converted photon 312 if quantum modem 300 is employed) and at least one phase shifter (e.g., first phase shifter 440 (FIG. 4)) configured to adjust a phase difference between one or more outputs of quantum router 400 (e.g., first and second outputs 414, 424).

In some aspects, quantum router 400 (e.g., PIC) can include a first splitter (e.g., first splitter 430 (FIG. 4)) configured to route entangled photon 112 (or tuned converted photon 312 if quantum modem 300 is employed), a first phase shifter (e.g., first phase shifter 440 (FIG. 4)) configured to adjust a phase difference between one or more intermediate waveguides of quantum router 400 (e.g., first and second waveguides 410, 420), a second splitter (e.g., second splitter 450 (FIG. 4)) configured to route entangled photon 112 (or tuned converted photon 312 if quantum modem 300 is employed), and a second phase shifter (e.g., second phase shifter 460 (FIG. 4)) configured to adjust a phase difference between one or more outputs of quantum router 400 (e.g., first and second outputs 414, 424). In some aspects, quantum router 400 (e.g., PIC) can be in a Mach-Zehnder interferometer configuration.

In some aspects, quantum router 400 can include one or more filters (e.g., optical filter, short pass filter, long pass filter, band pass filter, ring filter, or a combination thereof) to filter entangled photon 112 (or tuned converted photon 312 if quantum modem 300 is employed). For example, as shown in FIG. 14, quantum router 400″ can include filtering stage 470 configured to filter input photons (e.g., first and second entangled photons 112a, 112b, first and second tuned converted photons 312a, 312b) prior to routing the input photons via one or more quantum routers 400a, 400b, 400c.

In some aspects, quantum router 400 can be coupled to a plurality of quantum sources (e.g., first and second trapped ion stages 110a, 110b (FIG. 14.)). In some aspects, quantum router 400 can be configured to route a plurality of entangled photons (e.g., first and second entangled photons 112a, 112b, first and second tuned converted photons 312a, 312b (FIG. 14)) to one or more outputs of quantum router 400.

FIG. 2 illustrates quantum network 200 with trapped ion stage 110 and quantum router 400 (e.g., PIC), according to various exemplary aspects. Quantum network 200 can be configured to route (e.g., passively, actively, dynamically, or a combination thereof) entangled photons 112 from ion trap 104 to different nodes of quantum router 400 (e.g., PIC). Quantum network 100 can be further configured to convert (e.g., via one or more quantum modems 300) entangled photon 112 to near-infrared photons (e.g., about 750 nm to about 1260 nm) and/or telecommunication photons (e.g., about 1260 nm to about 1675 nm) to match an operating wavelength of quantum router 400 (e.g., PIC).

Although quantum network 200 is shown in FIG. 2 as a stand-alone apparatus and/or system, the aspects of this disclosure can be used with other apparatuses, systems, and/or methods, such as, but not limited to, elements in FIGS. 1 and 3-16, e.g., quantum network 100, quantum modem 300, quantum router 400, quantum network 200′, quantum network 100′, quantum network 100″, and/or flow diagram 1600.

The aspects of quantum network 100 shown in FIG. 1, for example, and the aspects of quantum network 200 shown in FIG. 2 may be similar. Similar reference numbers are used to indicate features of the aspects of quantum network 100 shown in FIG. 1 and the similar features of the aspects of quantum network 200 shown in FIG. 2. One difference between the aspects of quantum network 100 shown in FIG. 1 and the aspects of quantum network 200 shown in FIG. 2 is that quantum network 200 includes trapped ion stage 110, first, second, and third polarization assemblies 120, 130, 140 coupled to quantum router 400 by first input fiber 122, first output fiber 132, and second output fiber 142, respectively, and quantum router 400 (e.g., PIC) includes first phase shifter 440 and second phase shifter 460 coupled to first and second waveguides 410, 420 (e.g., active control).

As shown in FIG. 2, quantum network 200 can include trapped ion stage 110, quantum modem 300, first, second, and third polarization assemblies 120, 130, 140, and quantum router 400 (e.g., PIC). In some aspects, quantum network 200 can omit quantum modem 300, for example, utilizing entangled photon 112 from trapped ion stage 110 as input to quantum router 400 without any quantum frequency conversion.

Trapped ion stage 110 can be configured to emit entangled photon 112 and entangled reference photon 111. As shown in FIG. 2, trapped ion stage 110 can include trapped ion 102 (e.g., barium-138 ion), ion trap 104, reference detector 108 (e.g., photomultiplier tube), entangled reference photon 111, and entangled photon 112. Reference detector 108 can be configured to detect entangled reference photon 111 from ion trap 104. In some aspects, reference detector 108 can be coupled to a controller to provide a synchronization pulse to a time tagging module for one or more quantum communication operations. For example, the controller can include an advanced real-time infrastructure for quantum physics (ARTIQ) device.

First, second, and third polarization assemblies 120, 130, 140 can be configured to provide polarization control to entangled photon 112 (or to tuned converted photon 312 if quantum modem 300 is employed). First, second, and third polarization assemblies 120, 130, 140 can be further configured to be coupled to quantum router 400 (e.g., PIC) by first input fiber 122, first output fiber 132, and second output fiber 142, respectively. As shown in FIG. 2, first polarization assembly 120 can receive entangled photon 112, perform one or more polarization corrections to entangled photon 112, and route entangled photon 112 to first input 412 via first input fiber 122.

Second polarization assembly 130 can receive entangled photon 112 at first output 414, after one or more programmable operations, via first output fiber 132 (e.g., first entangled output photon 416), perform one or more polarization corrections to first entangled output photon 416, and pass first entangled output photon 416 to first detector 418. Third polarization assembly 140 can receive entangled photon 112 at second output 424, after one or more programmable operations, via second output fiber 142 (e.g., second entangled output photon 426), perform one or more polarization corrections to second entangled output photon 426, and pass second entangled output photon 416 to second detector 428. In some aspects, first input fiber 122, first output fiber 132, and second output fiber 142 (e.g., optical fibers) can have the same or similar operating wavelength as quantum router 400.

Quantum router 400 (e.g., PIC) can be configured to route entangled photon 112 (or tuned converted photon 312) to first and second outputs 414, 424. Quantum router 400 (e.g., PIC) can be further configured to perform one or more programmable operations on entangled photon 112 to control first and second entangled output photons 416, 426. As shown in FIG. 2, quantum router 400 (e.g., PIC) can include first splitter 430, first phase shifter 440, second splitter 450, and second phase shifter 460. In some aspects, as shown in FIG. 2, quantum router 400 can be a PIC. In some aspects, quantum router 400 (e.g., PIC) can be in a Mach-Zehnder interferometer configuration. In some aspects, quantum router 400 (e.g., PIC) can include active Mach-Zehnder interferometers (e.g., replacing first and second splitters 430, 450).

First splitter 430 can be configured to route entangled photon 112 between first and second waveguides 410, 420. First splitter 430 can be further configured to split (e.g., direct) entangled photon 112 from one input port (e.g., first input 412) to one or more output ports (e.g., first waveguide 410 and/or second waveguide 420). In some aspects, first splitter 430 can operate as a splitter (e.g., 50/50 splitter). In some aspects, first splitter 430 can operate as a combiner configured to combine (e.g., direct) entangled photons 112 from two input ports (e.g., first input 412 and second input 422) to one output port (e.g., second waveguide 420). In some aspects, first splitter 430 can include an active Mach-Zehnder interferometer device.

First phase shifter 440 can be configured to adjust a phase difference between first and second waveguides 410, 420. First phase shifter 440 can be further configured to act as an internal phase shifter to control a transmission and splitting ratio of entangled photon 112 at first and second outputs 414, 424. As shown in FIG. 2, first phase shifter 440 can be between first and second splitters 430, 450 (e.g., coupled to second waveguide 420) and include first electrode 442 (e.g., active) and second electrode 444 (e.g., common or ground) to apply a current to second waveguide 420, thereby changing a refractive index of second waveguide 420 (e.g., silicon nitride) and creating a phase shift between first and second waveguides 410, 420. In some aspects, first phase shifter 440 can include a thermo-optic phase shifter with current-driven heaters (e.g., chromium) on second waveguide 420.

In some aspects, a transmission of entangled photon 112 at first and second outputs 414, 424 can be controlled as a function of current applied to first phase shifter 440 (e.g., via first and second electrodes 442, 444). In some aspects, the transmission at first and second outputs 414, 424 can have a total transmission of at least 31%. In some aspects, a splitting ratio (e.g., 50%) of entangled photon 112 at first and second outputs 414, 424 can be controlled as a function of current applied to first phase shifter 440 (e.g., via first and second electrodes 442, 444).

Second splitter 450 can be configured to route entangled photon 112 between first and second waveguides 410, 420. Second splitter 450 can be further configured to split (e.g., direct) entangled photon 112 from one input port (e.g., first waveguide 410) to one or more output ports (e.g., first output 414 and/or second output 424). In some aspects, second splitter 450 can operate as a splitter (e.g., 50/50 splitter). In some aspects, second splitter 450 can operate as a combiner configured to combine (e.g., direct) entangled photons 112 from two input ports (e.g., first waveguide 410 and second waveguide 420) to one output port (e.g., second output 424). In some aspects, second splitter 450 can include an active Mach-Zehnder interferometer device.

Second phase shifter 460 can be configured to adjust a phase difference between first and second outputs 414, 424. Second phase shifter 460 can be further configured to act as an external phase shifter to adjust a phase difference of entangled photon 112 at first and second outputs 414, 424 to control two-photon interference when distributing entanglement. As shown in FIG. 2, second phase shifter 460 can be between second splitter 450 and first and second outputs 412, 424 (e.g., coupled to second waveguide 420) and include first electrode 462 (e.g., active) and second electrode 444 (e.g., common or ground) to apply a current to second waveguide 420, thereby changing a refractive index of second waveguide 420 (e.g., silicon nitride) and creating a phase shift between first and second outputs 412, 424. In some aspects, second phase shifter 460 can include a thermo-optic phase shifter with current-driven heaters (e.g., chromium) on second waveguide 420.

### Exemplary Quantum Modems

FIG. 3 illustrates quantum modem 300, according to various exemplary aspects. Quantum modem 300 can be configured to convert entangled photon 112 to tuned converted photon 312. Quantum modem 300 can be further configured to match (e.g., tune) a wavelength of entangled photon 112 to an operating wavelength of quantum router 400 via one or more QFC stages (e.g., first QFC stage 320 and/or second QFC stage 340), thereby generating tuned converted photon 312.

Although quantum modem 300 is shown in FIG. 3 as a stand-alone apparatus and/or system, the aspects of this disclosure can be used with other apparatuses, systems, and/or methods, such as, but not limited to, elements in FIGS. 1, 2, 4-16, e.g., quantum network 100, quantum network 200, quantum router 400, quantum network 200′, quantum network 100′, quantum network 100″, and/or flow diagram 1600.

As shown in FIG. 3, quantum modem 300 can include trapped ion stage 110, first QFC stage 320, second QFC stage 340, and background filter stage 360. Entangled photon 112 can be emitted from a trapped ion in trapped ion stage 110. In some aspects, entangled photon 112 can have a wavelength in the UV and visible regime, for example, about 493 nm. In some aspects, entangled photon 112 can be emitted from a quantum source, including but not limited to, a trapped ion, a single-photon source, or a quantum emitter.

In first QFC stage 320, entangled photon 112 can interact with first pump laser light 324 inside first QFC device 330 (e.g., a non-linear medium) to generate first converted photon 332 (e.g., about 780 nm). In some aspects, entangled photon 112 and first pump laser light 324 can interact in the non-linear medium (e.g., a waveguide) to generate first converted photon 332 through difference frequency conversion. In some aspects, first converted photon 332 can have a wavelength in the near-infrared regime (e.g., about 750 nm to about 1260 nm), for example, about 780 nm. In some aspects, first converted photon 332 can be entangled with entangled photon 112 (e.g., via QFC).

In some aspects, first pump laser light 324 can be generated by first pump laser 322 and can reflect from first dichroic mirror 326 before entering first QFC device 330. In some aspects, first converted photon 332 can have a frequency that is at least 12 THz higher than a frequency of first pump laser light 324.

In some aspects, first QFC device 330 can include a Sagnac interferometer configuration. In some aspects, first QFC device 330 can include a periodically poled lithium niobate (PPLN) waveguide. In some aspects, first QFC device 330 can have a signal-to-noise ratio (SNR) of at least 1.

In second QFC stage 340, first converted photon 332 (e.g., about 780 nm) and second pump laser light 344 can interact in second QFC device 350 (e.g., a non-linear medium) to generate second converted photon 352. In some aspects, first converted photon 332 and second pump laser light 344 can interact in the non-linear medium (e.g., a waveguide) to generate second converted photon 352 through difference frequency conversion. In some aspects, second converted photon 352 can have a wavelength in the telecommunication regime (e.g., about 1260 nm to about 1675 nm), for example, about 1534 nm (C-band). In some aspects, second converted photon 352 can be entangled with entangled photon 112 and first converted photon 332 (e.g., via QFC).

In some aspects, second pump laser 342 can generate second pump laser light 344. As shown in FIG. 3, second pump laser light 344 can pass through first high pass filter 345 and second high pass filter 346. In some aspects, first high pass filter 345 and second high pass filter 346 can be configured to remove noise from second pump laser light 344. In some aspects, second pump laser light 344 can also pass through polarization control 347 before it is reflected from dichroic mirror 348 into second QFC device 350. In some aspects, second converted photon 352 can have a frequency that is at least 12 THz higher than a frequency of second pump laser light 344.

In some aspects, second QFC device 350 can include a Sagnac interferometer configuration. In some aspects, second QFC device 350 can include a PPLN waveguide. In some aspects, second QFC device 350 can have a SNR of at least 1.

In some aspects, background filter stage 360 can be configured to filter noise photons 354 from second converted photon 352. Noise photons 354 can include second pump laser light 344, first converted photons 332 that do not efficiently undergo second QFC stage 340, and/or Raman anti-Stokes noise photons.

Background filter stage 360 can include low pass filter 362, high pass filter 364, and/or tunable filter 370. In some aspects, low pass filter 362 can be configured to block photons with wavelengths greater than about 1580 nm, for example, second pump laser light 344 (e.g., about 1589 nm). In some aspects, high pass filter 364 can be configured to block photons with wavelengths less than 1000 nm, for example, entangled photons 112 and/or first converted photons 332.

As shown in FIG. 3, filtered converted photons 366 can pass through tunable filter 370, resulting in tuned converted photons 312. In some aspects, tunable filter 370 can be configured to reduce Raman anti-Stokes noise photons. In some aspects, tunable filter 370 can have a bandwidth of about 20 GHz. In some aspects, quantum modem 300 can convert entangled photon 112 from a quantum source (e.g., trapped ion, single-photon source, quantum emitter) into a near-infrared photon (e.g., about 750 nm to about 1260 nm). In some aspects, quantum modem 300 can convert entangled photon 112 from a quantum source (e.g., trapped ion, single-photon source, quantum emitter) into a telecommunication photon (e.g., about 1260 nm to about 1675 nm). In some aspects, tuned converted photons 312 can have a wavelength in a telecommunication band (e.g., about 1260 nm to about 1675 nm), for example, the O-band (1260 nm to 1360 nm), the C-band (1530 nm to 1565 nm), and/or the E-band (1360 nm to 1460 nm).

In some aspects, quantum modem 300 can include first QFC stage 320, for example, to convert entangled photon 112 to tuned converted photon 312 in the near-infrared regime (e.g., about 750 nm to about 1260 nm). In some aspects, quantum modem 300 can include first QFC stage 320 and second QFC stage 340, for example, to convert entangled photon 112 to tuned converted photon 312 in the telecommunication regime (e.g., about 1260 nm to about 1675 nm).

### Exemplary Quantum Routers

FIGS. 4-12 illustrate quantum router 400 (e.g., PIC) and functionality of quantum router 400 (e.g., plots 500, 600, 700, 800, 900, 1000, 1100, 1200), according to various exemplary aspects. Quantum router 400 (e.g., PIC) can be configured to route one or more entangled photons 112 (or one or more tuned converted photons 312) to first and second outputs 414, 424. Quantum router 400 (e.g., PIC) can be further configured to perform one or more programmable operations on one or more entangled photons 112 to control first and second entangled output photons 416, 426. Quantum router 400 (e.g., PIC) can be further configured to control a transmission and splitting ratio of one or more entangled photons 112 (or tuned converted photons 312) at first and second outputs 414, 424.

Although quantum router 400 is shown in FIG. 4 as a stand-alone apparatus and/or system, the aspects of this disclosure can be used with other apparatuses, systems, and/or methods, such as, but not limited to, elements in FIGS. 1-3 and 13-16, e.g., quantum network 100, quantum network 200, quantum modem 300, quantum network 200′, quantum network 100′, quantum network 100″, and/or flow diagram 1600.

The aspects of quantum router 400 shown in FIG. 2, for example, and the aspects of quantum router 400 shown in FIG. 4 may be similar. Similar reference numbers are used to indicate features of the aspects of quantum router 400 shown in FIG. 2 and the similar features of the aspects of quantum router 400 shown in FIG. 4. One difference between the aspects of quantum router 400 shown in FIG. 2 and the aspects of quantum router 400 shown in FIG. 4 is that quantum router 400 includes first input fiber 122, second input fiber 126, first output fiber 132, and second output fiber 142 coupled to first input 412, second input 422, first output 414, and second output 424 of quantum router 400, respectively.

Discussion of quantum router 400 components and/or functionality (e.g., first waveguide 410, second waveguide 420, first splitter 430, first phase shifter 440, second splitter 450, second phase shifter 460) is not duplicated here for brevity, but the aspects and features of each are similar to quantum router 400 described above. In some aspects, first input fiber 122, second input fiber 126, first output fiber 132, and second output fiber 142 (e.g., optical fibers) can have the same or similar operating wavelength as quantum router 400.

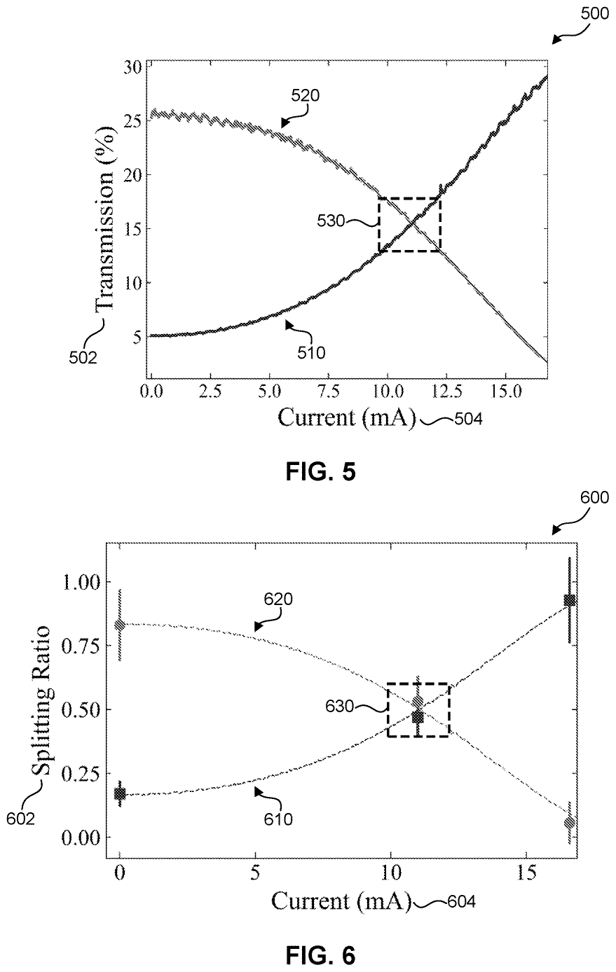

As discussed above, FIGS. 5-12 illustrate exemplary plots of quantum router 400, according to various exemplary aspects. FIG. 5 shows plot 500 of transmission as a function of current for quantum router 400, according to an exemplary aspect. As shown in FIG. 5, plot 500 shows transmission (%) 502 as a function of current (mA) 504 applied by first phase shifter 440 for first and second outputs 414, 424 of quantum router 400. Plot 500 includes first transmission output 510 (e.g., corresponding to photon transmission at first output 414), second transmission output 520 (e.g., corresponding to photon transmission at second output 424, and cross-over region 530 (e.g., region of equal transmission).

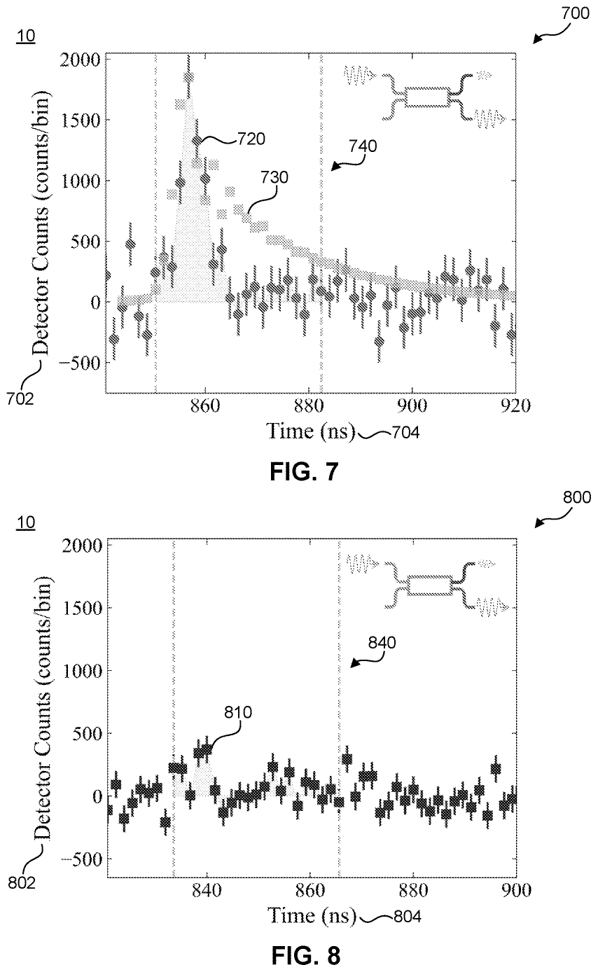

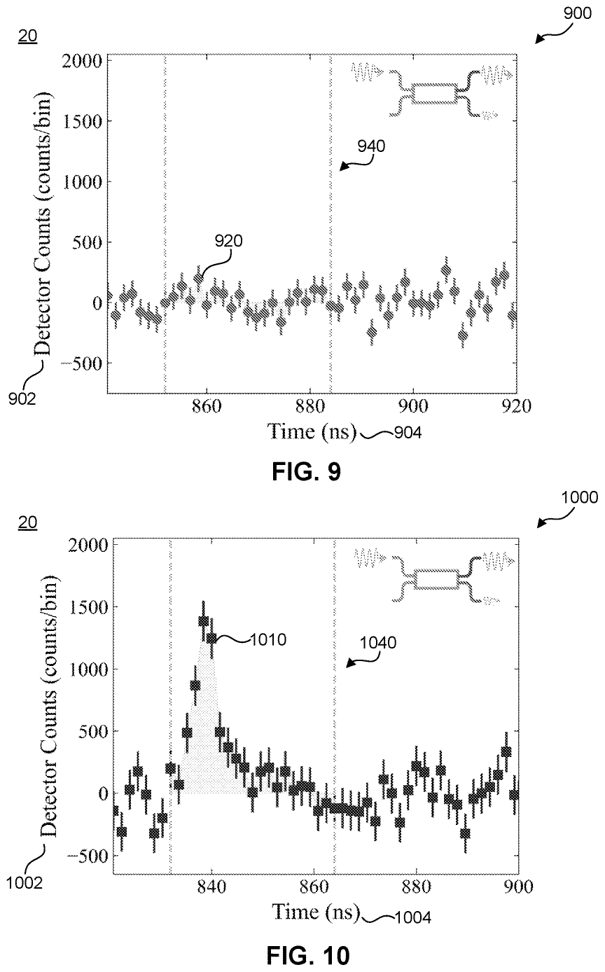

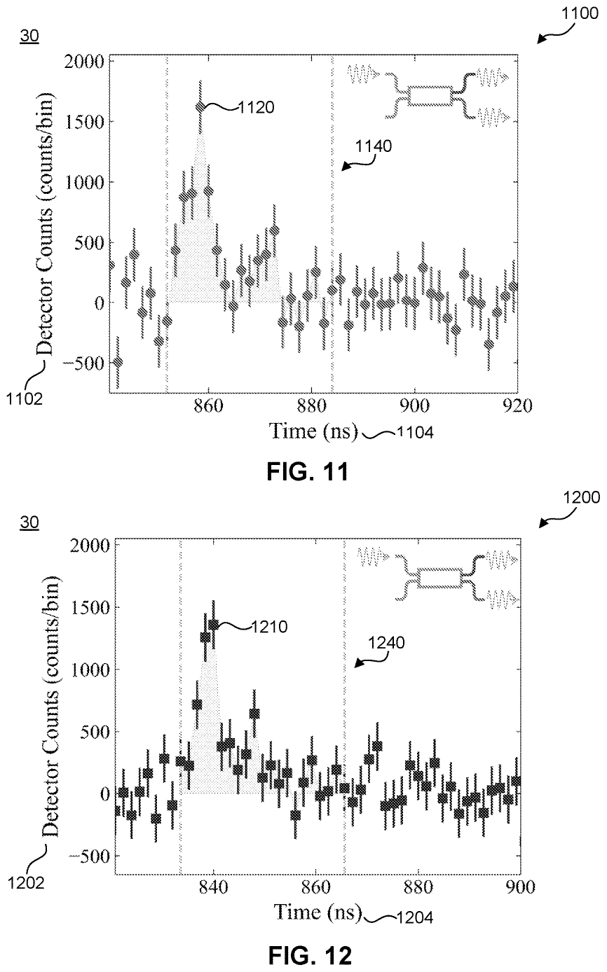

In some aspects, first phase shifter 440 can apply a current to control a transmission of first and second outputs 414, 424 of quantum router 400, for example, in one or more programmable configurations (e.g., 0%, 100%, 50%, etc.). In some aspects, first phase shifter 440 can apply a current of about 0 mA to isolate transmission of second output 424 (e.g., second transmission output 520) in a first configuration (e.g., first configuration 10 shown in FIGS. 7 and 8). In some aspects, first phase shifter 440 can apply a current of at least about 16 mA to isolate transmission of first output 414 (e.g., first transmission output 510) in a second configuration (e.g., second configuration 20 shown in FIGS. 9 and 10). In some aspects, first phase shifter 440 can apply a current of about 11 mA to evenly split transmission (e.g., 50/50) of first output 414 (e.g., first transmission output 510) and second output 424 (e.g., second transmission output 520) in a third configuration (e.g., third configuration 30 shown in FIGS. 11 and 12).

FIG. 6 shows plot 600 of splitting ratio as a function of current for quantum router 400, according to an exemplary aspect. As shown in FIG. 6, plot 600 shows splitting ratio 602 as a function of current (mA) 604 applied by first phase shifter 440 for first and second outputs 414, 424 of quantum router 400. Plot 600 includes first splitting ratio output 610 (e.g., corresponding to splitting ratio at first output 414), second splitting ratio output 620 (e.g., corresponding to splitting ratio at second output 424, and cross-over region 630 (e.g., region of equal splitting ratio, 50%).

In some aspects, first phase shifter 440 can apply a current to control a splitting ratio of first and second outputs 414, 424 of quantum router 400, for example, in one or more programmable configurations (e.g., 0%, 100%, 50%, etc.). In some aspects, first phase shifter 440 can apply a current of about 0 mA to isolate splitting ratio of second output 424 (e.g., second splitting ratio output 620) in a first configuration (e.g., first configuration 10 shown in FIGS. 7 and 8). In some aspects, first phase shifter 440 can apply a current of at least about 16 mA to isolate splitting ratio of first output 414 (e.g., first splitting ratio output 610) in a second configuration (e.g., second configuration 20 shown in FIGS. 9 and 10). In some aspects, first phase shifter 440 can apply a current of about 11 mA to apply an equal splitting ratio (e.g., 50/50) of first output 414 (e.g., first splitting ratio output 610) and second output 424 (e.g., second splitting ratio output 620) in a third configuration (e.g., third configuration 30 shown in FIGS. 11 and 12).

FIG. 7 shows plot 700 of time resolved photon counts for quantum router 400 in a first configuration 10, according to an exemplary aspect. As shown in FIG. 7, in first configuration 10, plot 700 shows detector counts 702 at second output 424 (e.g., via second detector 428) of quantum router 400 as a function of time (ns) 704. Plot 700 includes second photon counts output 720 (e.g., corresponding to time resolved photon counts of tuned converted photons 312 at second output 424), reference photon counts output 730 (e.g., corresponding to reference time resolved photon counts of entangled photons 112 at second output 424), and photon window 740.

A total number of second photon counts output 720 that reside within photon window 740 can be measured. In some aspects, photon window 740 can be about 20-40 nanoseconds. In some aspects, photon window 740 can correspond to about 75% of reference photon counts output 730. In some aspects, first configuration 10 can correspond to first phase shifter 440 applying a current of about 0 mA to isolate second output 424 (e.g., second photon counts output 720).

FIG. 8 shows plot 800 of time resolved photon counts for quantum router 400 in first configuration 10, according to an exemplary aspect. As shown in FIG. 8, in first configuration 10, plot 800 shows detector counts 802 at first output 414 (e.g., via first detector 418) of quantum router 400 as a function of time (ns) 804. Plot 800 includes first photon counts output 810 (e.g., corresponding to time resolved photon counts of tuned converted photons 312 at first output 414) and photon window 840.

As shown in FIGS. 7 and 8, in first configuration 10 (e.g., first phase shifter 440 applying a current of about 0 mA), nearly all single photon (e.g., tuned converted photons 312) are routed to second output 424 of quantum router 400.

FIG. 9 shows plot 900 of time resolved photon counts for quantum router 400 in a second configuration 20, according to an exemplary aspect. As shown in FIG. 9, in second configuration 20, plot 900 shows detector counts 902 at second output 424 (e.g., via second detector 428) of quantum router 400 as a function of time (ns) 904. Plot 900 includes second photon counts output 920 (e.g., corresponding to time resolved photon counts of tuned converted photons 312 at second output 424) and photon window 940. In some aspects, second configuration 20 can correspond to first phase shifter 440 applying a current of at least about 16 mA to isolate first output 414 (e.g., first photon counts output 1010 (FIG. 10)).

FIG. 10 shows plot 1000 of time resolved photon counts for quantum router 400 in second configuration 20, according to an exemplary aspect. As shown in FIG. 10, in second configuration 20, plot 1000 shows detector counts 1002 at first output 414 (e.g., via first detector 418) of quantum router 400 as a function of time (ns) 1004. Plot 1000 includes first photon counts output 1010 (e.g., corresponding to time resolved photon counts of tuned converted photons 312 at first output 414) and photon window 1040.

As shown in FIGS. 9 and 10, in second configuration 20 (e.g., first phase shifter 440 applying a current of at least about 16 mA), nearly all single photon (e.g., tuned converted photons 312) are routed to first output 414 of quantum router 400.

FIG. 11 shows plot 1100 of time resolved photon counts for quantum router 400 in a third configuration 30, according to an exemplary aspect. As shown in FIG. 11, in third configuration 30, plot 1100 shows detector counts 1102 at second output 424 (e.g., via second detector 428) of quantum router 400 as a function of time (ns) 1104. Plot 1100 includes second photon counts output 1120 (e.g., corresponding to time resolved photon counts of tuned converted photons 312 at second output 424) and photon window 1140. In some aspects, third configuration 30 can correspond to first phase shifter 440 applying a current of about 11 mA to evenly split (e.g., 50/50) first output 414 (e.g., first photon counts output 1210 (FIG. 12)) and second output 424 (e.g., second photon counts output 1120).

FIG. 12 shows plot 1200 of time resolved photon counts for quantum router 400 in third configuration 30, according to an exemplary aspect. As shown in FIG. 12, in third configuration 30, plot 1200 shows detector counts 1202 at first output 414 (e.g., via first detector 418) of quantum router 400 as a function of time (ns) 1204. Plot 1200 includes first photon counts output 1210 (e.g., corresponding to time resolved photon counts of tuned converted photons 312 at first output 414) and photon window 1240.

As shown in FIGS. 11 and 12, in third configuration 30 (e.g., first phase shifter 440 applying a current of about 11 mA), nearly all single photons (e.g., tuned converted photons 312) are evenly routed (e.g., 50/50 split) to first output 414 and second output 424 of quantum router 400.

### Exemplary Alternative Quantum Networks

FIG. 13 illustrates quantum network 200′ based on a plurality of trapped ion stages 110a, 110b and quantum router 400′ on microchip 202, according to an exemplary aspect. Quantum network 200′ can be configured to route (e.g., passively, actively, dynamically, or a combination thereof) a plurality of entangled photons 112a, 112b from a plurality of trapped ion stages 110a, 110b to different nodes of quantum router 400′ (e.g., PIC). Quantum network 200′ can be further configured to convert (e.g., via one or more quantum modems 300a, 300b) entangled photons 112a, 112b to near-infrared photons (e.g., about 750 nm to about 1260 nm) and/or telecommunication photons (e.g., about 1260 nm to about 1675 nm) to match an operating wavelength of quantum router 400′ (e.g., PIC). Quantum network 200′ can be further configured to perform one or more fundamental quantum operations (e.g., photonic Bell-state analysis) on a plurality of entangled photons 112a, 112b.

Although quantum network 200′ is shown in FIG. 13 as a stand-alone apparatus and/or system, the aspects of this disclosure can be used with other apparatuses, systems, and/or methods, such as, but not limited to, elements in FIGS. 1-12 and 14-16, e.g., quantum network 100, quantum network 200, quantum modem 300, quantum router 400, quantum network 100′, quantum network 100″, and/or flow diagram 1600.

The aspects of quantum network 200 shown in FIG. 2, for example, and the aspects of quantum network 200′ shown in FIG. 13 may be similar. Similar reference numbers are used to indicate features of the aspects of quantum network 200 shown in FIG. 2 and the similar features of the aspects of quantum network 200′ shown in FIG. 13. One difference between the aspects of quantum network 200 shown in FIG. 2 and the aspects of quantum network 200′ shown in FIG. 13 is that quantum network 200′ includes first and second trapped ion stages 110a, 110b, first and second quantum modems 300a, 300b, polarization assemblies 120a, 120b, 120c, 120d, quantum router 400′ with first and second quantum routers 400a, 400b (e.g., at 50/50 splitting condition), first, second, third, and fourth detectors 418a, 418b, 418c, 418d, and first and second time tagging modules 150a, 150b all on microchip 202.

Discussion of quantum router 400′ components and/or functionality (e.g., first waveguide 410, second waveguide 420, first splitter 430, first phase shifter 440, second splitter 450, second phase shifter 460) is not duplicated here for brevity, but the aspects and features of each are similar to quantum router 400 described above. In some aspects, first, second, third, and fourth input fibers 122a, 122b, 122c, 122d (e.g., optical fibers) can have the same or similar operating wavelength as quantum router 400′.

As shown in FIG. 13, quantum network 200′ can include microchip 202, first and second trapped ion stages 110a, 110b, first and second quantum modems 300a, 300b, first and second polarizing beam splitters (PBS) 118a, 118b, first, second, third, and fourth polarization assemblies 120a, 120b, 120c, 120d coupled to first, second, third, and fourth input fibers 122a, 122b, 122c, 122d, quantum router 400′, first, second, third, and fourth detectors 418a, 428a, 418b, 428b, and first and second time tagging modules 150a, 150b.

In some aspects, first and second trapped ion stages 110a, 110b and quantum router 400′ can be disposed on microchip 202. In some aspects, microchip 202 can be part of quantum router 400′. In some aspects, microchip 202 can include a photonic chip, printed circuit board, PIC, or a combination thereof. In some aspects, quantum router 400′ can include first and second quantum routers 400a, 400b configured to form a 2×2 cross-connecting array for four inputs (e.g., [symbol] , [symbol] , [symbol] , and [symbol] , corresponding to first, second, third, and fourth input fibers 122a, 122b, 122c, 122d, respectively) and four outputs (e.g., [symbol] , [symbol] , [symbol] , and [symbol] , corresponding to first, third, second, and fourth detectors 418a, 418b, 428a, 428b, respectively). In some aspects, first and second quantum routers 400a, 400b can each be in a Mach-Zehnder interferometer configuration at a 50/50 splitting ratio. In some aspects, first, second, third, and fourth detectors 418a, 428a, 418b, 428b can each include a superconducting nanowire single photon detector (SNSPD).

As shown in FIG. 13, first and second trapped ion stages 110a, 110b can generate first and second entangled photons 112a, 112b from first and second ion traps 104a, 104b on microchip 202. First and second entangled photons 112a, 112b (e.g., wavelength of about 493 nm) can be converted to first and second tuned converted photons 312a, 312b via first and second quantum modems 300a, 300b, respectively. First and second tuned converted photons 312a, 312b can pass through first and second PBS 118a, 118b that separate first and second tuned converted photons 312a, 312b into orthogonal polarizations (e.g., p-polarized (in the plane) and s-polarized (perpendicular to the plane), respectively. Orthogonal polarizations of first and second tuned converted photons 312a, 312b can pass through first, second, third, and fourth polarization assemblies 120a, 120b, 120c, 120d and be routed through first, second, third, and fourth input fibers 122a, 122b, 122c, 122d coupled to quantum router 400′ as four inputs (e.g., [symbol] , [symbol] , [symbol] , and [symbol] ), respectively.

Quantum router 400′ can apply one or more programmable operations to the four inputs (e.g., [symbol] , [symbol] , [symbol] , and [symbol] ), for example, first and second quantum routers 400a, 400b can each be in a Mach-Zehnder interferometer configuration at a 50/50 splitting ratio and generate four outputs (e.g., [symbol] , [symbol] , [symbol] , and [symbol] ) coupled to first, third, second, and fourth detectors 418a, 418b, 428a, 428b, respectively. First and third detectors 418a, 418b can be coupled to first time tagging module 150a, and second and fourth detectors 428a, 428b can be coupled to second time tagging module 150b to perform one or more fundamental quantum operations (e.g., photonic Bell-state analysis). In some aspects, quantum network 200′ can mediate entanglement between first and second trapped ion stages 110a, 110b (e.g., distanced from one another) utilizing first and second quantum routers 400a, 400b (e.g., in Mach-Zehnder interferometer configuration at 50/50 splitting ratio), deemed dual-rail flying qubits. For example, in dual-rail flying qubits, the presence of first and second entangled photons 112a, 112b in each optical path (e.g., first and second input fibers 122a, 122b and third and fourth input fibers 122c, 122d, respectively) are entangled with the internal spin state of the ion in first and second ion traps 104a, 104b, respectively.

FIG. 14 illustrates quantum network 100′ based on a plurality of quantum sources 110a, 110b coupled to quantum router 400″, according to an exemplary aspect. Quantum network 100′ can be configured to route (e.g., passively, actively, dynamically, or a combination thereof) first and second entangled photons 112a, 112b from first and second quantum sources 110a, 110b (e.g., trapped ions) between different nodes of quantum router 400″. Quantum network 100′ can be further configured for programmable routing and entanglement distribution, for example, filtering and cross-connecting first and second entangled photons 112a, 112b in a 3×3 array via quantum router 400″. Quantum network 100′ can be further configured for distributed quantum computing between first and second quantum sources 110a, 110b.

Although quantum network 100′ is shown in FIG. 14 as a stand-alone apparatus and/or system, the aspects of this disclosure can be used with other apparatuses, systems, and/or methods, such as, but not limited to, elements in FIGS. 1-13, 15, and 16, e.g., quantum network 100, quantum network 200, quantum modem 300, quantum router 400, quantum network 200′, quantum network 100″, and/or flow diagram 1600.

The aspects of quantum network 100 shown in FIG. 1, for example, and the aspects of quantum network 100′ shown in FIG. 14 may be similar. Similar reference numbers are used to indicate features of the aspects of quantum network 100 shown in FIG. 1 and the similar features of the aspects of quantum network 100′ shown in FIG. 14. One difference between the aspects of quantum network 100 shown in FIG. 1 and the aspects of quantum network 100′ shown in FIG. 14 is that quantum network 100′ includes first and second quantum sources 110a, 110b, first and second quantum modems 300a, 300b, and quantum router 400″ with filtering stage 470 and first, second, and third quantum routers 400a, 400b, 400c (e.g., at 50/50 splitting condition) for cross-connecting first and second entangled photons 112a, 112b, for example, in a 3×3 array.

Discussion of quantum router 400″ components and/or functionality (e.g., first waveguide 410, second waveguide 420, first splitter 430, first phase shifter 440, second splitter 450, second phase shifter 460) is not duplicated here for brevity, but the aspects and features of each are similar to quantum router 400 and quantum router 400′ described above. In some aspects, quantum router 400″ can perform 3×3 unitary transformations on first and second entangled photons 112a, 112b and can serve as photonic cross-connects.

As shown in FIG. 14, quantum network 100′ can include first and second quantum sources 110a, 110b, first and second quantum modems 300a, 300b, and quantum router 400″. In some aspects, quantum router 400″ can include first, second, and third quantum routers 400a, 400b, 400c configured to form a 3×3 cross-connecting array for three inputs (e.g., first and second entangled photons 112a, 112b) and three outputs (e.g., first and second entangled output photons 416b, 416c). In some aspects, first, second, and third quantum routers 400a, 400b, 400c can each be in a Mach-Zehnder interferometer configuration at a 50/50 splitting ratio.

In some aspects, quantum router 400″ can include filtering stage 470 configured to filter first and second entangled photons 112a, 112b (or first and second tuned converted photons 312a, 312b). In some aspects, each input of quantum router 400″ can include a corresponding filter, for example, first, second, and third filters 472a, 472b, 472c. In some aspects, first, second, and third filters 472a, 472b, 472c can include an optical filter, short pass filter, long pass filter, band pass filter, ring filter, or a combination thereof.

As shown in FIG. 14, first and second quantum sources 110a, 110b can generate first and second entangled photons 112a, 112b. First and second entangled photons 112a, 112b (e.g., wavelength of about 493 nm) can be converted to first and second tuned converted photons 312a, 312b via first and second quantum modems 300a, 300b, respectively. First and second tuned converted photons 312a, 312b can be routed into quantum router 400″ (e.g., at first and third inputs). Quantum router 400″ can filter first and second tuned converted photons 312a, 312b, for example, via first and third filters 472a, 472c, respectively. Quantum router 400″ can apply one or more programmable operations (e.g., 3×3 unitary transformations) to first and second tuned converted photons 312a, 312b, for example, via first, second, and third quantum routers 400a, 400b, 400c and output first and second entangled output photons 416b, 416c, respectively. In some aspects, quantum router 400″ can perform one or more fundamental quantum operations (e.g., photonic Bell-state analysis) on first and second entangled photons 112a, 112b. In some aspects, quantum router 400″ can perform unitary transformations (e.g., 3×3) or any arbitrary number of unitary transformations (e.g., 2×2, 3×3, 4×4, etc.) on first and second entangled photons 112a, 112b (or first and second tuned converted photons 312a, 312b).

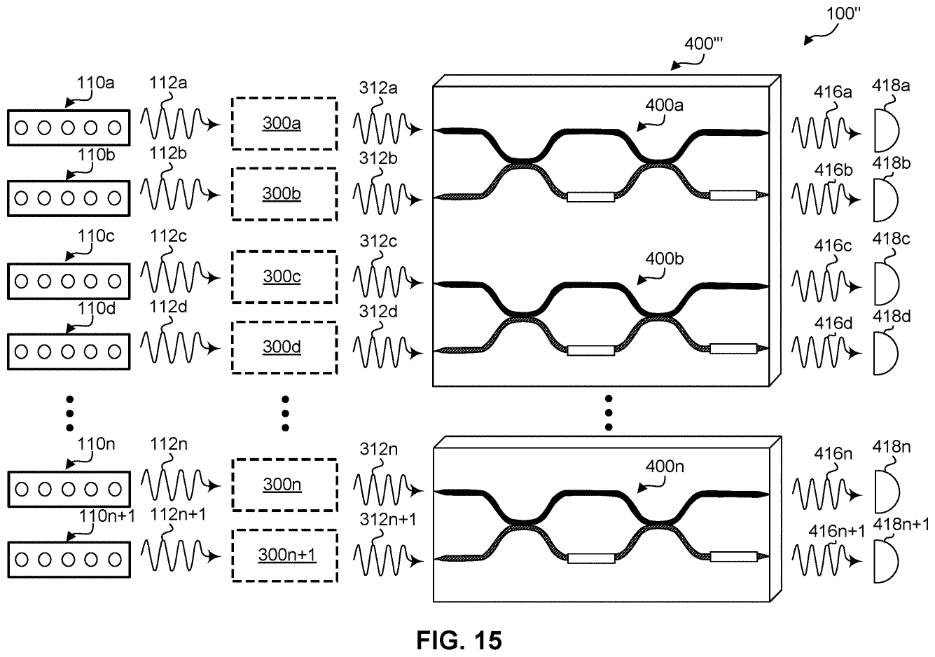

FIG. 15 illustrates quantum network 100″ based on a plurality of quantum sources 110a, 110b, . . . , 110n, 110n+1 and quantum router 400′, according to an exemplary aspect. Quantum network 100″ can be configured to route (e.g., passively, actively, dynamically, or a combination thereof) a plurality of entangled photons 112a, 112b, . . . , 112n, 112n+1 from a plurality of quantum sources 110a, 110b, . . . , 110n, 110n+1 (e.g., trapped ions) between different nodes of quantum router 400′. Quantum network 100″ can be further configured for programmable routing and entanglement distribution, for example, filtering and cross-connecting a plurality of entangled photons 112a, 112b, . . . , 112n, 112n+1 in a N×N array, where Nis any positive integer (e.g., 1, 2, 3, 4, 5, 10, 50, 100, 500, 1,000, etc.), via quantum router 400′. Quantum network 100″ can be further configured for distributed quantum computing between a plurality of quantum sources 110a, 110b, . . . , 110n, 110n+1.

Although quantum network 100″ is shown in FIG. 15 as a stand-alone apparatus and/or system, the aspects of this disclosure can be used with other apparatuses, systems, and/or methods, such as, but not limited to, elements in FIGS. 1-14 and 16, e.g., quantum network 100, quantum network 200, quantum modem 300, quantum router 400, quantum network 200′, quantum network 100′, and/or flow diagram 1600.

The aspects of quantum network 100 shown in FIG. 1, for example, and the aspects of quantum network 100″ shown in FIG. 15 may be similar. Similar reference numbers are used to indicate features of the aspects of quantum network 100 shown in FIG. 1 and the similar features of the aspects of quantum network 100″ shown in FIG. 15. One difference between the aspects of quantum network 100 shown in FIG. 1 and the aspects of quantum network 100″ shown in FIG. 15 is that quantum network 100″ includes a plurality of quantum sources 110a, 110b, . . . , 110n, 110n+1, a plurality of quantum modems 300a, 300b, . . . , 300n, 300n+1, and quantum router 400″ with a plurality of quantum routers 400a, 400b, . . . , 400n (e.g., at 50/50 splitting condition) for cross-connecting a plurality of entangled photons 112a, 112b, . . . , 112n, 112n+1 (or a plurality of tuned converted photons 312a, 312b, . . . , 312n, 312n+1) in a programmable way, for example, in a N×N array.

Discussion of quantum router 400″ components and/or functionality (e.g., first waveguide 410, second waveguide 420, first splitter 430, first phase shifter 440, second splitter 450, second phase shifter 460) is not duplicated here for brevity, but the aspects and features of each are similar to quantum router 400, quantum router 400′, and quantum router 400″ described above. In some aspects, quantum router 400″ can perform N×N unitary transformations on a plurality of entangled photons 112a, 112b, . . . , 112n, 112n+1 and can serve as photonic cross-connects.

As shown in FIG. 15, quantum network 100″ can include plurality of quantum sources 110a, 110b, . . . , 110n, 110n+1, plurality of quantum modems 300a, 300b, . . . , 300n, 300n+1, and quantum router 400″. In some aspects, quantum router 400″ can include plurality of quantum routers 400a, 400b, . . . , 400n configured to form a N×N cross-connecting array for up to n+1 inputs (e.g., plurality of entangled photons 112a, 112b, . . . , 112n, 112n+1) and up to n+1 outputs (e.g., plurality of entangled output photons 416a, 416b, . . . , 416n, 416n+1). In some aspects, plurality of quantum routers 400a, 400b, . . . , 400n can each be in a Mach-Zehnder interferometer configuration at a 50/50 splitting ratio.

As shown in FIG. 15, plurality of quantum sources 110a, 110b, . . . , 110n, 110n+1 can generate plurality of entangled photons 112a, 112b, . . . , 112n, 112n+1, respectively. Plurality of entangled photons 112a, 112b, . . . , 112n, 112n+1 (e.g., wavelength of about 493 nm) can be converted to plurality of tuned converted photons 312a, 312b, . . . , 312n, 312n+1 via plurality of quantum modems 300a, 300b, . . . , 300n, 300n+1, respectively. Plurality of tuned converted photons 312a, 312b, . . . , 312n, 312n+1 can be routed into quantum router 400″ (e.g., for n+1 inputs). Quantum router 400′ can apply one or more programmable operations (e.g., N×N unitary transformations) to plurality of tuned converted photons 312a, 312b, . . . , 312n, 312n+1, for example, via plurality of quantum routers 400a, 400b, . . . , 400n and output plurality of entangled output photons 416a, 416b, . . . , 416n, 416n+1, respectively. In some aspects, quantum router 400′ can perform one or more fundamental quantum operations (e.g., photonic Bell-state analysis) on plurality of entangled photons 112a, 112b, . . . , 112n, 112n+1. In some aspects, quantum router 400″ can perform unitary transformations (e.g., N×N) or any arbitrary number of unitary transformations (e.g., 2×2, 3×3, 4×4, 5×5, 10×10, 50×50, 100×100, 500×500, 1,000×1,000, etc.) on plurality of entangled photons 112a, 112b, . . . , 112n, 112n+1 (or plurality of tuned converted photons 312a, 312b, . . . , 312n, 312n+1).

### Exemplary Flow Diagram

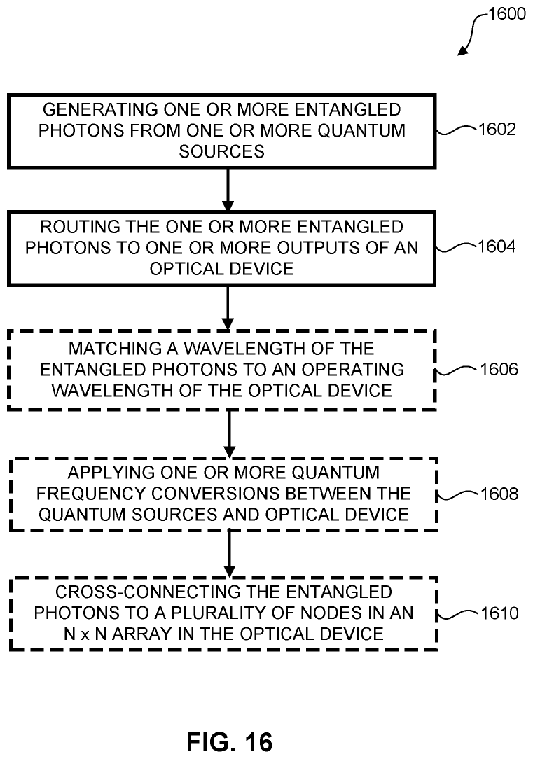

FIG. 16 illustrates flow diagram 1600 according to an exemplary aspect. For example, flow diagram 1600 can be for quantum network 100 shown in FIG. 1. Flow diagram 1600 can be configured to route (e.g., passively, actively, dynamically, or a combination thereof) one or more entangled photons from one or more quantum sources to different nodes of a quantum router (e.g., PIC). Flow diagram 1600 can be further configured to convert (e.g., via one or more quantum modems) one or more entangled photons to near-infrared photons (e.g., about 750 nm to about 1260 nm) and/or telecommunication photons (e.g., about 1260 nm to about 1675 nm) to match an operating wavelength of a quantum router (e.g., PIC).

It is to be appreciated that not all steps in FIG. 16 are needed to perform the disclosure provided herein. Further, some of the steps may be performed simultaneously, sequentially, and/or in a different order than shown in FIG. 16. Flow diagram 1600 shall be described with reference to FIGS. 1-15. However, flow diagram 1600 is not limited to those example aspects. Although flow diagram 1600 is shown in FIG. 16 as a stand-alone method, the aspects of this disclosure can be used with other apparatuses, systems, and/or methods, such as, but not limited to, elements in FIGS. 1-15, e.g., quantum network 100, quantum network 200, quantum modem 300, quantum router 400, quantum network 200′, quantum network 100′, and/or quantum network 100″. In some aspects, flow diagram 1600 can be implemented by quantum network 100, quantum network 200, quantum network 200′, quantum network 100′, and/or quantum network 100″.

In step 1602, as shown in the example of FIGS. 1-15, one or more entangled photons (e.g., entangled photon 112 (FIG. 1)) can be generated from one or more quantum sources (e.g., quantum source 110 (FIG. 1)).

In step 1604, as shown in the example of FIGS. 1-15, the one or more entangled photons (e.g., entangled photon 112 (FIG. 1)) can be routed to one or more outputs (e.g., first and second outputs 414, 424 (FIG. 1)) of a quantum router (e.g., quantum router 400 (FIG. 1)). In some aspects, routing the one or more entangled photons (e.g., entangled photon 112 (FIG. 1)) can include switching the one or more entangled photons between the one or more outputs (e.g., first and second outputs 414, 424 (FIG. 1)) with one or more splitters (e.g., first and second splitters 430, 450 (FIG. 4)) and one or more phase shifters (e.g., first and second phase splitters 440, 460 (FIG. 4)).

In step 1606, optionally, a wavelength of the one or more entangled photons (e.g., entangled photon 112 (FIG. 1)) can be matched to an operating wavelength of the quantum router (e.g., quantum router 400 (FIG. 1)). In some aspects, the wavelength of the one or more entangled photons (e.g., entangled photon 112 (FIG. 1)) can be in the ultraviolet and visible regime of about 100 nm to about 750 nm. In some aspects, the operating wavelength of the quantum router (e.g., quantum router 400 (FIG. 1)) can be in the ultraviolet and visible regime of about 100 nm to about 750 nm, the near-infrared regime of about 750 nm to about 1260 nm, or the telecommunication regime of about 1260 nm to about 1675 nm.

In step 1608, optionally, one or more quantum frequency conversions (QFCs) can be applied (e.g., via quantum modem 300 (FIG. 1)) between the one or more quantum sources (e.g., quantum source 110 (FIG. 1)) and the quantum router (e.g., quantum router 400 (FIG. 1)).

In step 1610, optionally, the one or more entangled photons (e.g., plurality of entangled photons 112a, 112b, . . . , 112n, 112n+1 (FIG. 15)) can be cross-connected to a plurality of nodes in an N×N array in the quantum router (e.g., quantum router 400″ (FIG. 15)).

While specific aspects have been described above, it will be appreciated that the aspects may be practiced otherwise than as described. The description is not intended to limit the scope of the claims.

It is to be appreciated that the Detailed Description section, and not the Summary and Abstract sections, is intended to be used to interpret the claims. The Summary and Abstract sections may set forth one or more but not all exemplary aspects as contemplated by the inventor(s), and thus, are not intended to limit the aspects and the appended claims in any way.

The aspects have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the aspects that others can, by applying knowledge within the skill of the art, readily modify and/or adapt for various applications such specific aspects, without undue experimentation, without departing from the general concept of the aspects. Therefore, such adaptations and modifications are intended to be within the meaning and range of equivalents of the disclosed aspects, based on the teaching and guidance presented herein.

It is to be understood that the phraseology or terminology herein is for the purpose of description and not of limitation, such that the terminology or phraseology of the present specification is to be interpreted by the skilled artisan in light of the teachings and guidance.

The breadth and scope of the aspects should not be limited by any of the above-described exemplary aspects, but should be defined only in accordance with the following claims and their equivalents.

1. A system comprising:
a quantum source configured to emit an entangled photon; and
an optical device coupled to the quantum source and configured to route the entangled photon to one or more outputs.

2. The system of claim 1, wherein a wavelength of the entangled photon is in the ultraviolet and visible regime of about 100 nm to about 750 nm.

3. The system of claim 1, wherein the quantum source comprises a trapped ion, a single-photon source, a quantum emitter, a superconducting qubit, a photonic qubit, or a combination thereof.

4. The system of claim 1, wherein the quantum source is disposed on the optical device.

5. (canceled)

6. (canceled)

7. (canceled)

8. (canceled)

9. The system of claim 1, wherein the optical device comprises an active optical device.

10. The system of claim 9, wherein the active optical device comprises a photonic integrated circuit.

11. (canceled)

12. The system of claim 10, wherein the photonic integrated circuit comprises:
at least one splitter configured to route the entangled photon; and
at least one phase shifter configured to adjust a phase difference between the one or more outputs.

13. The system of claim 12, wherein the photonic integrated circuit comprises:
a first splitter configured to route the entangled photon;
a first phase shifter configured to adjust a phase difference between one or more intermediate waveguides;
a second splitter configured to route the entangled photon; and
a second phase shifter configured to adjust a phase difference between the one or more outputs.

14. The system of claim 13, wherein the photonic integrated circuit is in a Mach-Zehnder interferometer configuration.

15. The system of claim 12, wherein the photonic integrated circuit comprises an optical filter, a short pass filter, a long pass filter, a band pass filter, or a combination of filters configured to filter the entangled photon.

16. (canceled)

17. (canceled)

18. (canceled)

19. (canceled)

20. (canceled)

21. A method of routing entangled photons between different nodes, the method comprising:
generating one or more entangled photons from one or more quantum sources; and
routing the one or more entangled photons to one or more outputs of an optical device coupled to the one or more quantum sources.

22. The method of claim 21, further comprising matching a wavelength of the one or more entangled photons to an operating wavelength of the optical device.

23. The method of claim 22, wherein matching the wavelength comprises applying one or more quantum frequency conversion stages between the one or more quantum sources and the optical device.

24. The method of claim 22, wherein:
the wavelength of the entangled photon is in the ultraviolet and visible regime of about 100 nm to about 750 nm, and
the operating wavelength of the optical device is in the ultraviolet and visible regime of about 100 nm to about 750 nm, the near-infrared regime of about 750 nm to about 1260 nm, or the telecommunication regime of about 1260 nm to about 1675 nm.

25. The method of claim 21, wherein routing the one or more entangled photons comprises switching the one or more entangled photons between the one or more outputs with one or more splitters and one or more phase shifters.

26. The method of claim 21, wherein routing comprises cross-connecting the one or more entangled photons to a plurality of nodes in an N×N array in the optical device.

27. A quantum network comprising:
two or more quantum sources each configured to emit an entangled photon;
two or more quantum modems, wherein each quantum modem is coupled to a quantum source and configured to convert emitted entangled photons produced by the quantum source into telecommunication photons of about 1260 nm to about 1675 nm through one or more quantum frequency conversion devices; and
a quantum router configured to receive the telecommunication photons and route the telecommunication photons to one or more outputs.

28. The quantum network of claim 27, wherein a wavelength of the telecommunication photons matches an operating wavelength of the quantum router.

29. The quantum network of claim 27, wherein the quantum router comprises a multi-mode interferometer, a photonic integrated circuit, or a combination thereof.

30. The quantum network of claim 27, wherein the quantum network is configured for distributed quantum computing between the two or more quantum sources.
